(19) United States
(12) Patent Application Publication
(10) Pub. No.: US 2009/0171839 A1
(43) Pub. Date: Jul. 2, 2009

(54) SYSTEMS AND METHODS FOR PROCESSING RECURRING PAYMENT TRANSACTIONS

(76) Inventors: Sharon A. Rosano, New Canaan, CT (US); Ernesto Cabrera, O'Fallon, MO (US); Susan Snodgrass, Saint Charles, MO (US)

Correspondence Address: DANIEL M. FITZGERALD (21652);ARMSTRONG TEASDALE LLP, ONE METROPOLITAN SQUARE, SUITE 2600, ST. LOUIS, MO, 63102-2740, US

(21) Appl. No.: 11/966,549

(22) Filed: Dec. 28, 2007

(51) Int. Cl. G06Q 40/00

(52) U.S. Cl. 705/40

(57) ABSTRACT

Systems and methods for updating payment card records in real time for payment cards registered to be used for recurring payments in which the payment card itself is not present. In one aspect, a method for processing card-not-present recurring payment (CNP/RP) transactions is provided. The transactions include recurring purchases made by a cardholder using payment card information stored by a merchant. The method includes receiving, at an interchange network, a first authorization request message for the transaction, and querying a database coupled to the interchange network to determine whether the database includes updated payment card information for a payment card used in the transaction. The method also includes transmitting the updated payment card information from the interchange network to the merchant and updating the payment card information stored by the merchant to match the updated payment card information received from the interchange network.

### BACKGROUND OF THE INVENTION

This invention relates generally to systems and methods for processing payment transactions and, more particularly, to systems and methods for processing recurring payment transactions that include automatically updating payment card records for payment cards registered to be used for the transaction in which the payment card itself is not present.

The payment card industry includes payment transactions wherein the transaction is recurring and the payment card is not present for the transactions. These transactions are sometimes referred to as “card-not-present recurring payment” (CNP/RP) transactions. Specifically, CNP/RP transactions are payment transactions that use payment card information stored by a merchant and wherein the payment card is not present for the actual transaction. For example, a health club member may wish to avoid mailing a monthly check for club membership dues. The member may instead register a payment card, such as a credit card, a debit card, or a prepaid card, with the club, enabling the club to automatically charge the payment card for the monthly dues on a particular day each month. In some such systems, the merchant stores an account number, an expiration date, and/or other information associated with the payment card and/or cardholders.

In the event that some or all of the merchant-stored payment card information changes, there is a risk that payment transactions will be denied due to the use of stale information. In such a case, the merchant must contact the cardholder in order to update the merchant records, or the cardholder must contact the merchant to report a change in information.

At least some systems enable merchants to submit billing files to a processing center or interchange in order for the files to be updated with up to date payment card information. The new information is submitted to the processing center by an issuing bank that holds the account associated with the payment card. The updated payment card information may be submitted to the processing center for each individual update or may be submitted in bulk for better efficiency.

None of the known recurring payment systems are capable of checking for updated payment card information in real time during a CNP/RP transaction. Accordingly, a system and method for real-time updating of payment card information stored by a merchant is needed, wherein the payment card information is updated, and the transaction is authorized or denied at the time of the transaction.

### BRIEF DESCRIPTION OF THE INVENTION

In one aspect, a method for processing card-not-present recurring payment (CNP/RP) transactions is provided. The transactions include recurring purchases made by a cardholder using payment card information stored by a merchant. The method includes receiving, at an interchange network, a first authorization request message for the transaction, and querying a database coupled to the interchange system to determine whether the database includes updated payment card information for a payment card used in the transaction. The method also includes transmitting the updated payment card information from the interchange network to the merchant and updating the payment card information stored by the merchant to match the updated payment card information received from the interchange network.

In another aspect, a network-based system for processing card-not-present recurring payment (CNP/RP) transactions is provided, wherein the transactions include recurring purchases made by a cardholder using payment card information stored by a merchant. The system includes a computer associated with the merchant and coupled to a merchant database for storing information for a payment card that is registered to be used in the transaction, an interchange network that includes an interchange database for storing updated information for the payment card, and an interchange server configured to be coupled to the merchant computer and the interchange database. The interchange server is further configured to receive, from the merchant computer, a first authorization request message for the transaction, and query the interchange database to determine whether the interchange database includes updated payment card information for the payment card registered to be used in the transaction. The interchange server is also configured to transmit the updated payment card information to the merchant computer for updating the payment card information stored in the merchant database to match the payment card information stored in the interchange database.

In a further aspect, a computer coupled to a database for processing card-not-present recurring payment (CNP/RP) transactions is provided, the transactions including recurring purchases made by a cardholder using payment card information stored by a merchant. The computer is programmed to receive a first authorization request message from the merchant, determine whether a database includes updated payment card information for the payment card used in the transaction, and transmit the updated payment card information to the merchant for updating the payment card information stored by the merchant to match the updated payment card information.

In another aspect, a computer program embodied on a computer readable medium for processing card-not-present recurring payment (CNP/RP) transactions is provided. The transactions include recurring purchases made by a cardholder using payment card information stored by a merchant. The computer program includes at least one code segment that receives payment card information stored by the merchant, the payment card being used in a CNP/RP transaction, compares the payment card information stored by the merchant to payment card information stored in a database, and determines whether the database includes updated payment card information for a payment card used in the transaction. The code segment also transmits the updated payment card information to the merchant for updating the payment card information stored by the merchant to match the updated payment card information.

### BRIEF DESCRIPTION OF THE DRAWINGS

FIG. 1 is a simplified block diagram of a conventional billing update process.

FIG. 2 is a simplified block diagram of an exemplary embodiment of a server architecture of a system in accordance with one embodiment of the present invention.

FIG. 3 is an expanded block diagram of an exemplary embodiment of a server architecture of a system in accordance with one embodiment of the present invention.

FIG. 4 is a simplified flowchart illustrating an exemplary process utilized by the system shown in FIG. 3 for processing a recurring payment transaction.

### DETAILED DESCRIPTION OF THE INVENTION

As used herein, an acquiring bank, or acquirer, is typically a bank at which a merchant holds an account. In addition, an issuing bank, or issuer, is typically a bank at which a customer, or cardholder, holds an account, which may be debited or charged through the use of a debit card or a credit card. In at least some cases, the acquiring bank and the issuing bank may be the same entity.

As used herein, a processor may include any programmable system including systems using microcontrollers, reduced instruction set circuits (RISC), application specific integrated circuits (ASICs), logic circuits, and any other circuit or processor capable of executing the functions described herein. The above examples are exemplary only, and are thus not intended to limit in any way the definition and/or meaning of the term “processor.”

Described in detail herein are exemplary embodiments of systems and methods that facilitate updating, in real time, payment card information stored by a merchant for use in recurring payment transactions in which a card is not presented to the merchant, also called CNP/RP transactions. The systems and methods facilitate, for example, transferring new payment card information electronically over a network to update payment card information stored by a merchant that is found to be stale due to a change in card status and/or the issuance of a new card to the cardholder by an issuing bank. A technical effect of the systems and methods described herein include at least one of (a) creating a first authorization request message that includes current payment card information stored by a merchant and transmitting the first authorization request message from an acquirer to an interchange network; (b) identifying the first authorization request message as a CNP/RP transaction by reading a flag signifying such; (c) determining whether a database coupled to the interchange network includes new or updated payment card information for the payment card used in the CNP/RP transaction; (d) if the database includes updated payment card information, transmitting the updated information to the merchant, wherein the merchant updates the stale payment card information; (e) creating a second authorization request message that includes the updated payment card information and transmitting the second authorization request message from the acquirer to the interchange network; (f) when the database does not include updated payment card information, transmitting the first authorization request message from the interchange network to an issuer or, when the database does include updated payment card information, transmitting the second authorization request message from the interchange network to the issuer; and (g) processing the first authorization request message or second authorization request message to generate either an authorization code, thereby approving the transaction, or a denial transaction code.

In one embodiment, a computer program is provided, and is embodied on a computer readable medium. The program utilizes a Structured Query Language (SQL) with a client user interface front-end for administration and a web interface for standard user inputs and reports. In an exemplary embodiment, the system is web-enabled and is run on a business entity intranet. In an alternative embodiment, the system is fully accessible by individuals having and authorized access outside the firewall of the business-entity through the Internet. In a further alternative embodiment, the system is run in a Windows® environment (Windows is a registered trademark of Microsoft Corporation, Redmond, Wash.). The application is flexible and designed to run in various different environments without compromising any major functionality.

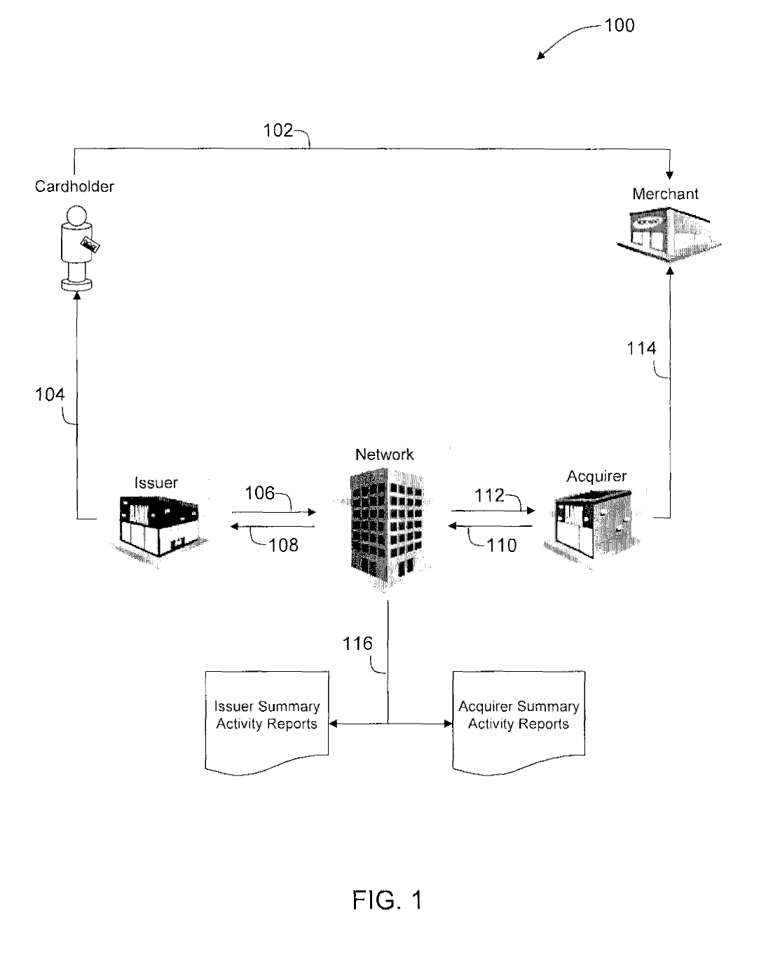

FIG. 1 is a flowchart 100 illustrating a conventional billing update process. The process begins when a cardholder establishes 102 a recurring payment relationship with a merchant. The cardholder provides payment card information to the merchant, enabling the merchant to periodically charge the cardholder for a good or service by automatically charging the payment card on file. For example, the cardholder enters the payment card information into a web browser and submits the payment card information to the merchant, and the merchant stores the payment card information in a database and/or server. The payment card information used by the merchant may include the cardholder's name as it appears on the payment card, a billing address, an account number or card number of the payment card, and/or an expiration date of the payment card.

At some point after the cardholder establishes 102 the recurring payment relationship with the merchant, an issuing bank, or issuer, sends 104 the cardholder a replacement payment card or may change one or more piece of payment card information, such as the expiration date. This may be due to a loss of the payment card by the cardholder or a reissue of the payment card due to the passage of the payment card expiration date. In such a case, the new payment card information is not on file with the merchant. Thus, when the merchant attempts to charge the cardholder for a recurring payment using the payment card information stored by the merchant, the transaction is at risk of being denied due to the stale payment card information. To prevent a denial, the issuer may be enrolled in an update service that uses a MasterCard® interchange network (MasterCard International Incorporated, Purchase, N.Y.). The MasterCard® interchange network is a proprietary communications standard promulgated by MasterCard International Incorporated® for the exchange of financial transaction data between financial institutions that are members of MasterCard International Incorporated®. The issuer sends 106 updated payment card information to the interchange network, which stores 108 the updated payment card information.

Acquiring banks, or acquirers, may also enroll in such an update service in order to collect updated payment card information and to pass the updated payment card information to merchants. For example, an acquirer may periodically query 110 the interchange network for updated payment card information for payment cards associated with recurring payment transactions that have been denied because of stale information stored by a merchant. The interchange network determines 112 whether there exists updated payment card information and, if so, sends the updated information to the acquirer. The acquirer then sends 114 the updated payment card information to the merchant and the merchant updates the stale payment card information. Additionally, such a process includes a periodic report 116 of updated payment card information that is sent to acquirers and issuers.

Financial transaction cards, or payment cards, may refer to credit cards, debit cards, and prepaid cards. These cards may all be used as a method of payment for performing a transaction, such as a recurring transaction. As described herein, the term “financial transaction card” or “payment card” includes cards such as credit cards, debit cards, and prepaid cards, but also includes any other device that may hold payment account information for use in recurring transactions, such as mobile phones, personal digital assistants (PDAs), and key fobs.

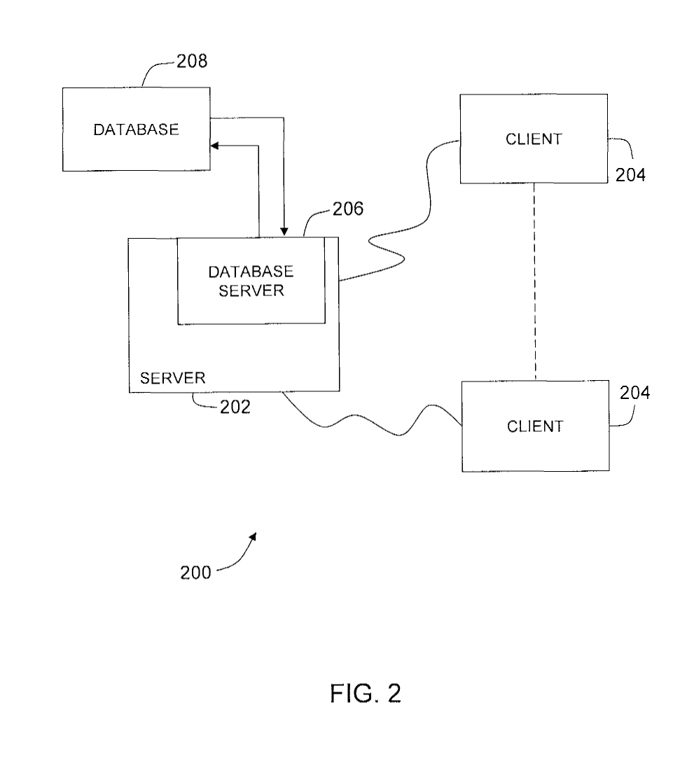

FIG. 2 is a simplified block diagram of an exemplary system 200 in accordance with one embodiment of the present invention. In one embodiment, system 200 is the financial transaction card payment system shown in FIG. 1, which may be utilized for processing recurring payments. More specifically, in the exemplary embodiment, system 200 includes a server system 202 and a plurality of client sub-systems, also referred to as client systems 204, connected to server system 202. In one embodiment, client systems 204 are computers including a web browser, such that server system 202 is accessible to client systems 204 using the Internet. Client systems 204 are interconnected to the Internet through may interfaces including a network, such as a local area network (LAN) and/or a wide area network (WAN), dial-in connections, cable modems, wireless connections, and special high-speed ISDN lines. Client systems 204 may be any device capable of interconnecting to the Internet including a web-based phone, personal digital assistant (PDA), or other web-connectable equipment. A database server 206 is connected to a database 208 containing information on a variety of matters, as described below in greater detail. In one embodiment, database 208 is stored on server system 202 and may be accessed by potential users at one of client systems 204 by logging onto server system 202 through one of client systems 204. In any alternative embodiment, database 208 is stored remotely from server system 202 and may be non-centralized.

As discussed below, payment card information including account numbers, expiration dates, and account statuses, such as whether the account is open or closed, is stored within database 208. Data relating to the cardholder of a payment card may also be stored within database 208.

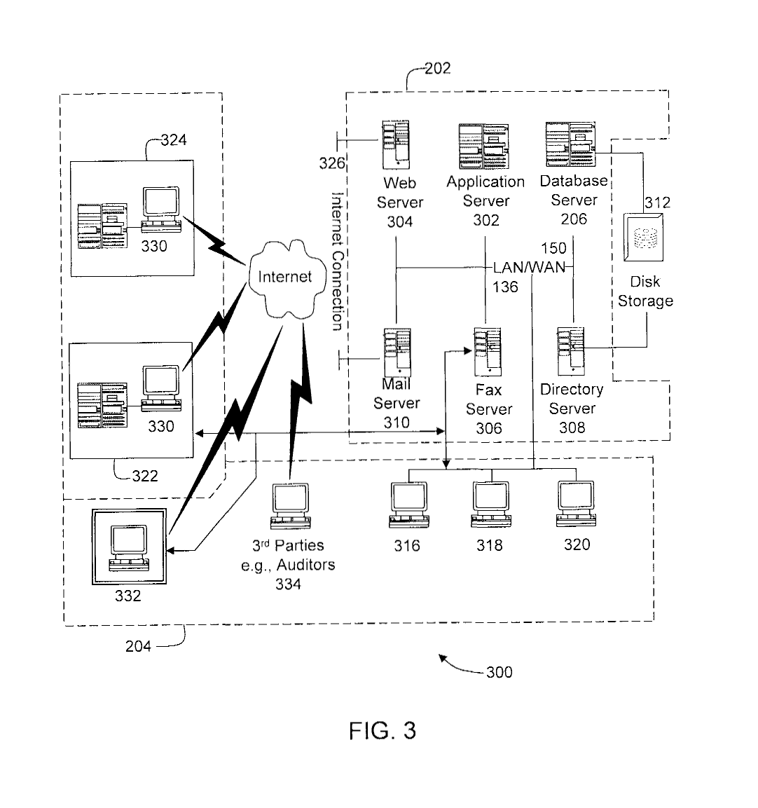

FIG. 3 is an expanded block diagram of an exemplary embodiment of a server architecture of a system 300 in accordance with one embodiment of the present invention. Components in system 300, identical to components of system 200 (shown in FIG. 2), are identified in FIG. 3 using the same reference numerals used in FIG. 2. System 300 includes server system 202 and client systems 204. Server system 202 further includes database server 206, an application server 302, a web server 304, a fax server 306, a directory server 308, and a mail server 310. A disk storage unit 312 is coupled to database server 206 and directory server 308. Servers 206, 302, 304, 306, 308, and 310 are coupled in a local area network (LAN) 314. In addition, a system administrator's workstation 316, a user workstation 318, and a supervisor's workstation 320 are coupled to LAN 314. Alternatively, workstations 316, 318, and 320 are coupled to LAN 314 using an Internet link or are connected through an Intranet.

Each workstation, 316, 318, and 320, is a personal computer having a web browser. Although the functions performed at the workstations typically are illustrated as being performed at respective workstations 316, 318, and 320, such functions can be performed at one of many personal computers coupled to LAN 314. Workstations 316, 318, and 320 are illustrated as being associated with separate functions only to facilitate an understanding of the different types of functions that can be performed by individuals having access to LAN 314.

Server system 202 is configured to be communicatively coupled to various entities, including acquirers 322 and issuers 324, and to third parties, e.g., auditors, 334 using an Internet connection 326. The communication in the exemplary embodiment is illustrated as being performed using the Internet, however, any other wide area network (WAN) type communication can be utilized in other embodiments, i.e., the systems and processes are not limited to being practiced using the Internet. In addition, and rather than WAN 328, local area network 314 could be used in place of WAN 328.

In the exemplary embodiment, any authorized individual or entity having a workstation 330 may access system 300. At least one of the client systems includes a manager workstation 332 located at a remote location. Workstations 330 and 332 are personal computers having a web browser. Also, workstations 330 and 332 are configured to communicate with server system 202. Furthermore, fax server 306 communicates with remotely located client systems, including a client system 332, using a telephone link. Fax server 306 is configured to communicate with other client systems 316, 318, and 320 as well.

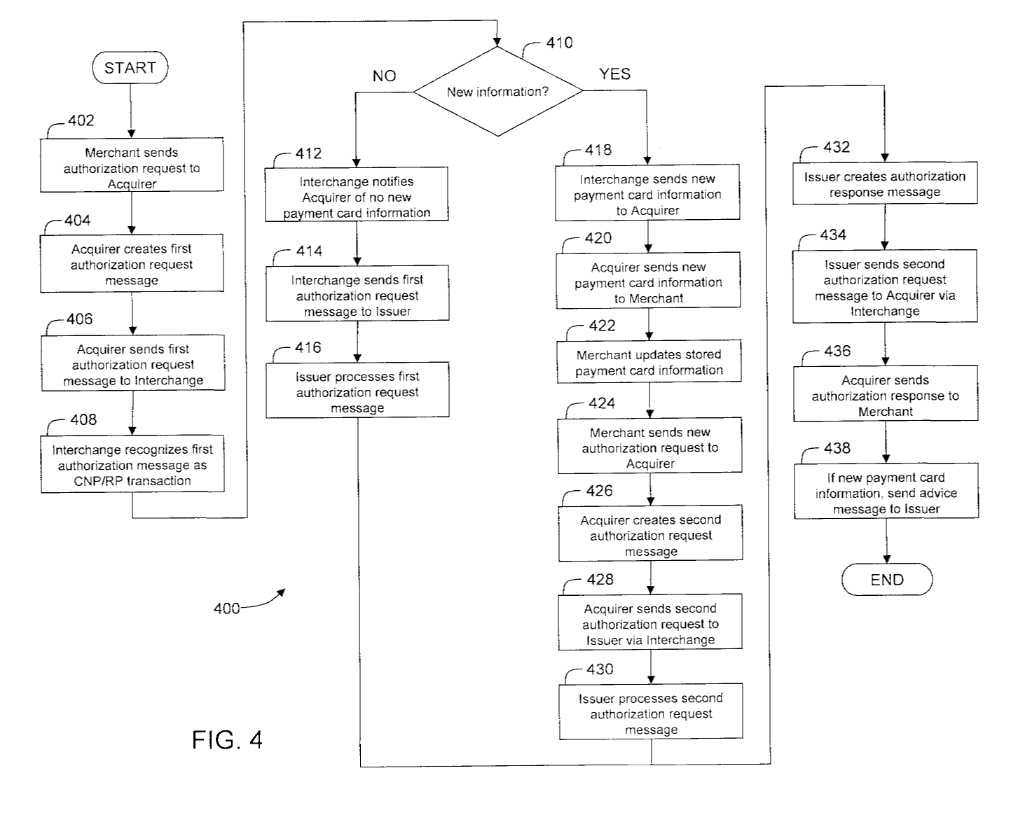

FIG. 4 is a simplified flowchart 400 illustrating an exemplary process utilized by system 300 shown in FIG. 3 for processing a recurring payment transaction. System 300 is sometimes referred to as the recurring payment transaction system, which may be utilized for processing recurring payments using payment card information stored by a merchant. In the exemplary embodiment, system 300 may be utilized by an issuer that issues a payment card, a consumer or cardholder who uses the payment card to tender payment for a recurring purchase from a merchant, a merchant that sells a product or service, an acquirer, and a credit card network or interchange network for processing the payment transaction. System 300 may also be utilized by the payment card network or interchange network to send updated payment card information to a merchant for updating stale payment card information stored by the merchant.

In the exemplary embodiment, system 300 facilitates updating stale payment card information. A technical effect of the systems and methods described herein is achieved by storing, by a cardholder, payment card information at a merchant. For example, the cardholder may enter the payment card information using a web browser or may enter the payment card information into a paper form while at the merchant. The payment card information may include information such as an account or card number, an expiration date for the payment card, and/or an account status such as open or closed. The merchant then uses the stored payment card information for periodic, or recurring, transactions. In so doing, the merchant sends 402 an authorization request to acquirer 322 (shown in FIG. 3). Acquirer 322 receives the authorization request and creates 404 a first authorization request message based on information included in the authorization request, such as an identifier, or flag, signifying that the transaction is a recurring payment transaction in which the card is not presented to the merchant. The first authorization request message also includes the transaction amount, an issuer identifier, an acquirer identifier, an account number associated with the payment card, an expiration date associated with the payment card, and/or an account status of the account associated with the payment card. The first authorization request message is formatted to enable the message to be communicated over an interchange network, such as the MasterCard® interchange network. Acquirer 322 then sends 406 the first authorization request message to the interchange network, or server system 202 (shown in FIG. 3).

Upon receiving the first authorization request message, server system 202, by using the flag, identifies 408 the transaction as a card-not-present recurring payment (CNP/RP) transaction. In one embodiment, the interchange network also verifies that acquirer 322 and issuer 324 (shown in FIG. 3) are members of the interchange network, by checking the issuer identifier and acquirer identifier included in the first authorization request message. In the exemplary embodiment, server system 202 then determines 410 whether the payment card information included in the first authorization request message is stale. Server system 202 queries database 208 (shown in FIG. 2) to determine whether database 208 includes updated payment card information. In one embodiment, database 208 includes payment card information for those payment cards having new information for a predetermined period, such as three months or six months. In an alternative embodiment, database 208 includes payment card information for all payment cards, and server system 202 matches the payment card information included in the first authorization request message with the payment card information stored in database 208.

In the exemplary embodiment, if database 208 does not include updated payment card information, server system 202 sends 412 a notification message to acquirer 322 showing that database 208 does not include updated information. Server system 202 also sends 414 the first authorization request message to issuer 324. Issuer 324 processes 416 the first authorization request message to generate either an authorization code, signifying that the transaction is authorized, or a denial code, signifying that the transaction is denied. For example, issuer 324 may deny the transaction if authorizing the transaction would cause the account associated with the payment card to exceed a predetermined credit limit. As another example, issuer 324 may deny the transaction if authorizing the transaction would cause the account associated with the payment card to be overdrawn, beyond a current account balance. After issuer 324 processes 416 the transaction, issuer 324 creates 432 an authorization response message that includes either an authorization code or a denial code for the transaction. The authorization response message is formatted to enable the message to be communicated over the interchange network. Issuer 324 sends 434 the authorization response message to acquirer 322, via server system 202. Acquirer 322 then sends 436 an authorization code or denial code to the merchant.

In the exemplary embodiment, if database 208 does include updated payment card information, server system 202 sends 418 the new payment card information to acquirer 322, which then sends 420 the new payment card information to the merchant. The merchant updates 422 the payment card information stored by the merchant, using the new payment card information. For example, if the updated account number stored by database 208 differs from the account number stored by the merchant, the merchant will update its stored account number to match the account number stored by database 208. As another example, if the account status stored by database 208 signifies that the account has been closed, the merchant will update its stored payment card information accordingly. In one embodiment, the account or recurring payments associated with that payment card may be marked in order to prompt the merchant to contact the cardholder regarding the recurring payments. After the payment card information has been updated, the merchant sends 424 a second authorization request to acquirer 322. Acquirer 322 then creates 426 a second authorization request message and sends 428 the second authorization request message to issuer 324 via the interchange network. The second authorization request message includes substantially similar elements as the first authorization request message, as described above. In one embodiment, the second authorization request message may also include a flag signifying that the payment card information has already been updated by the merchant, enabling server system 202 to bypass querying database 208 for new payment card information.

Issuer 324 processes 430 the second authorization request message and creates 432 an authorization response message, as described above. Issuer 324 then sends 434 the authorization response message to acquirer 322 via the interchange network. Acquirer 322 then sends 436 an authorization code or denial code to the merchant. If the second authorization request message includes a flag signifying that the payment card information was updated by the merchant, server system 202 sends 438 an advice message to issuer 324. The advice message includes that the first authorization request message was not approved and includes a reason, i.e., that the merchant attempted to use stale payment card information.

The systems and methods described herein enable real time payment card information updates to be made by a merchant during a transaction, without delays involved with requiring the merchant to contact the cardholder for the updated information. The merchant is instantly aware that the payment card information has changed, which reduces the need to delay the transaction until the cardholder or issuing bank is contacted. In addition, the issuing bank, the acquiring bank, and the merchant benefit from lower rates of transaction denials due to stale information stored by the merchant. This lowers the cost of operations for the issuing bank, acquiring bank, and/or merchant by alleviating the need to contact the cardholder, and also results in greater satisfaction for the cardholder in that the payment card information only needs to be entered at the initial setup of the recurring payment.

Although the systems and methods described herein are described in the context of real time payment card information updates, it is understood that the apparatus and methods are not limited to such systems and/or methods. Likewise, the system components illustrated are not limited to the specific embodiments herein, but rather, components of the system may be utilized independently and separately from other components described herein.

While the invention has been described in terms of various specific embodiments, those skilled in the art will recognize that the invention can be practiced with modification within the spirit and scope of the claims.

What is claimed is:

1. A method for processing card-not-present recurring payment (CNP/RP) transactions including recurring purchases made by a cardholder using payment card information stored by a merchant, said method comprising:
receiving, at an interchange network, a first authorization request message for the transaction;
querying a database coupled to the interchange network to determine whether the database includes updated payment card information for a payment card used in the transaction;
transmitting the updated payment card information from the interchange network to the merchant; and
updating the payment card information stored by the merchant to match the updated payment card information received from the interchange network.

2. A method in accordance with claim 1 wherein receiving a first authorization request message comprises creating the first authorization request message, wherein the first authorization request includes a flag that signifies that the first authorization request relates to a CNP/RP transaction.

3. A method in accordance with claim 1 wherein receiving a first authorization request message comprises identifying, by the interchange network, the first authorization request message as relating to a CNP/RP transaction.

4. A method in accordance with claim 1 wherein querying a database comprises determining whether the database includes an account number associated with the payment card that is different from an account number stored by the merchant for the payment card associated with the transaction.

5. A method in accordance with claim 1 wherein querying a database comprises determining whether the database includes an expiration date associated with the payment card that is different from an expiration date stored by the merchant for the payment card associated with the transaction.

6. A method in accordance with claim 1 wherein querying a database comprises determining whether the database includes an account cancellation flag associated with the payment card signifying that the account has been canceled.

7. A method in accordance with claim 1 wherein transmitting the updated payment card information for the interchange system to the merchant comprises creating an authorization response message that includes a flag that signifies that the authorization response message includes the updated payment card information.

8. A method in accordance with claim 1 wherein updating the payment card information stored by the merchant comprises:
creating a second authorization request message that includes the updated payment card information obtained from the database;
transmitting the second authorization request message to an issuer;
processing the second authorization request message to generate an authorization response message including one of an authorization code for the transaction and a denial code for the transaction; and
transmitting the authorization response message to the merchant.

9. A method in accordance with claim 1 wherein the database does not include updated payment card information for the payment card used in the transaction, said method further comprises:
transmitting the first authorization request message to an issuer;
processing the first authorization message to generate an authorization response message including one of an authorization code for the transaction and a denial code for the transaction; and
transmitting the authorization response message to the merchant.

10. A network-based system for processing card-not-present recurring payment (CNP/RP) transactions including recurring purchases made by a cardholder using payment card information stored by a merchant, said system comprising:
a computer associated with the merchant, said merchant computer coupled to a merchant database for storing information for a payment card that is registered to be used in the transaction;
an interchange network comprising an interchange database for storing updated information for the payment card and an interchange server configured to be coupled to said merchant computer and said interchange database, said interchange network server further configured to:
receive, from said merchant computer, a first authorization request message for the transaction;
query said interchange database to determine whether said interchange database includes updated payment card information for the payment card registered to be used in the transaction; and
transmit the updated payment card information to said merchant computer, wherein said merchant database updates the payment card information stored in said merchant database to match the payment card information stored in said interchange database.

11. A system in accordance with claim 10 wherein said merchant computer is configured to create the first authorization request message that includes a flag that signifies that the first authorization request message relates to a CNP/RP transaction.

12. A system in accordance with claim 10 wherein said interchange server is further configured to identify the first authorization request message as relating to a CNP/RP transaction.

13. A system in accordance with claim 10 wherein said interchange server is further configured to query said interchange database to determine whether said interchange database includes at least one of:
an account number associated with the payment card that is different from an account number stored in said merchant database for the payment card associated with the transaction;
an expiration date associated with the payment card that is different from an expiration date stored in said merchant database for the payment card associated with the transaction; and
an account cancellation flag associated with the payment card signifying that the account has been canceled.

14. A system in accordance with claim 10 wherein said interchange server is further configured to create an authorization response message that includes a flag that signifies the presence of updated payment card information within the authorization response message.

15. A system in accordance with claim 10 further comprising computer associated with an issuer, said issuer computer configured to be coupled to said interchange server, said merchant computer further configured to:
create a second authorization request message that includes the updated payment card information; and
transmit the second authorization request message to said issuer computer, wherein said issuer computer is further configured to process the second authorization request message to create an authorization response message including one of an authorization code for the transaction and a denial code for the transaction.

16. A system in accordance with claim 10 wherein said interchange database does not include update payment card information, said interchange server is further configured to transmit the first authorization request message to a computer associated with an issuer, said issuer computer is configured to process the first authorization request message to create an authorization response message including one of an authorization code for the transaction and a denial code for the transaction.

17. A computer coupled to a database for processing card-not-present recurring payment (CNP/RP) transactions including recurring purchases made by a cardholder using payment card information stored by a merchant, said computer programmed to:
receive a first authorization request message from the merchant;
determine whether a database includes updated payment card information for the payment card used in the transaction; and
transmit the updated payment card information to the merchant, wherein the merchant updates the payment card information stored by the merchant to match the updated payment card information.

18. A computer in accordance with claim 17 wherein said computer is further programmed to identify the first authorization request message as relating to a CNP/RP transaction based on a CNP/RP flag inserted into the first authorization request message by the merchant.

19. A computer in accordance with claim 17 wherein said computer is further programmed to determine whether the database includes updated payment card information by querying the database for at least one of:
an account number associated with the payment card that is different from an account number stored by the merchant for the payment card associated with the transaction;
an expiration date associated with the payment card that is different from an expiration date stored by the merchant for the payment card associated with the transaction; and
an account cancellation flag associated with the payment card signifying that the account has been canceled.

20. A computer in accordance with claim 17 wherein said computer is further programmed to create an authorization response message that includes a flag signifying the presence of updated payment card information within the authorization response message, wherein the merchant uses the updated payment card information to modify the stored payment card information.

21. A computer program embodied on a computer readable medium for processing card-not-present recurring payment (CNP/RP) transactions including recurring purchases made by a cardholder using payment card information stored by a merchant, said computer program comprising at least one code segment that:
receives payment card information stored by the merchant, the payment card being used in a CNP/RP transaction;
compares the payment card information stored by the merchant to payment card information stored in a database;
determines whether the database includes updated payment card information for a payment card used in the transaction; and
transmits the updated payment card information to the merchant, wherein the merchant updates the payment card information stored by the merchant to match the updated payment card information.

22. A computer program in accordance with claim 21 further comprising at least one code segment that creates a first authorization request message that includes a flag that signifies that the first authorization request message relates to the CNP/RP transaction.

23. A computer program in accordance with claim 22 further comprising at least one code segment that determines whether the first authorization request message relates to the CNP/RP transaction based on the flag.

24. A computer program in accordance with claim 21 further comprising at least one code segment that determines whether the database includes at least one of:
an account number associated with the payment card that is different from an account number stored by the merchant for the payment card associated with the transaction;
an expiration date associated with the payment card that is different from an expiration date stored by the merchant for the payment card associated with the transaction;
an account cancellation flag associated with the payment card signifying that the account has been canceled; and
creates an authorization response message that includes a flag signifying the presence of updated payment card information within the authorization response message.

25. A computer program in accordance with claim 22 further comprising at least one code segment that creates a second authorization request message that includes the updated payment card information, wherein the second authorization request message is processed by an issuer to create an authorization response message including one of an authorization code for the transaction and a denial code for the transaction.
